(19) United States
(12) Patent Application Publication
(10) Pub. No.: US 2022/0097618 A1
(43) Pub. Date: Mar. 31, 2022

(54) Vehicular Electronics Module Installation and Removal

(71) Applicant: Nissan North America, Inc., Franklin, TN (US)

(72) Inventors: Michael Rhyne, Royal Oak, MI (US); Darin Dalton, Farmington Hills, MI (US)

(21) Appl. No.: 17/038,825

(22) Filed: Sep. 30, 2020

(51) Int. Cl. B60R 11/02; B60K 37/04

(52) U.S. Cl. CPC B60R 11/02; B60R 2011/0047; B60K 37/04

(57) ABSTRACT

A vehicle is disclosed that includes: an electronics module (e.g., an audio unit, a GPS unit, etc.); an instrument panel that is configured to receive the electronics module; and first and second brackets that are secured to the electronics module. The instrument panel includes a first track and a second track collectively defining a non-linear installation and removal path for the electronics module, and the first and second brackets include first and second bosses that are configured for insertion into the first and second tracks, respectively.

### TECHNICAL FIELD

The present disclosure relates to the installation (and removal) of electronics modules in vehicles. More specifically, the present disclosure relates to the installation (and removal) of audio units, GPS units, etc., in a vehicle's instrument panel.

### BACKGROUND

During a typical installation procedure, an electronics module is externally secured to a vehicle's instrument panel using fasteners, clips, or the like, which are then hidden or otherwise obscured using a trim (finishing) component. While such installation procedures ease serviceability, they can often result in an unsightly seam that detracts from the overall aesthetic appearance of the vehicle's instrument panel.

To address this concern, the present disclosure describes improved installation method (and associated structures and components) that maintain serviceability without disrupting the design of the instrument panel.

### SUMMARY

In one aspect of the present disclosure, a vehicle is disclosed that includes: an electronics module (e.g., an audio unit, a GPS unit, etc.); an instrument panel that is configured to receive the electronics module; and first and second brackets that are secured to the electronics module. The instrument panel includes a first track and a second track that collectively define a non-linear installation and removal path for the electronics module, and the first and second brackets include first and second bosses that are configured for insertion into the first and second tracks, respectively.

In certain embodiments, the electronics module may include a bezel that extends about a periphery thereof.

In certain embodiments, the bezel may define a tongue that is configured for insertion into a groove defined by the instrument panel.

In certain embodiments, the bezel may be secured to a structural frame of the electronics module. For example, in certain embodiments, the bezel may be heat staked to the structural frame of the electronics module.

In certain embodiments, the first track and the second track may each include a first segment and a second segment that is offset from the first segment along an axis that extends in transverse (e.g., generally orthogonal) relation to a direction of insertion of the electronics module.

In certain embodiments, the first track and the second track may be (generally) identical in configuration.

In certain embodiments, the first bracket may be secured to a first side of the electronics module and the second bracket may be secured to a second side of the electronics module that is opposite to the first side.

In certain embodiments, the first bracket and the second bracket may be non-identical.

In certain embodiments, the second bracket may include a configuration mirroring that of the first bracket.

In certain embodiments, the first bracket may include a first upper flange that is configured to receive a first fastener and a first lower flange that is configured to receive a second fastener.

In certain embodiments, the second bracket may include a second upper flange that is configured to receive a third fastener and a second lower flange that is configured to receive a fourth fastener.

In certain embodiments, the first upper flange, the second upper flange, the first lower flange, and the second lower flange may each extend transversely in relation to a direction of insertion of the electronics module.

In certain embodiments, the first upper flange may extend inwardly towards the second upper flange, the first lower flange may extend inwardly toward the second lower flange, the second upper flange may extend inwardly towards the first upper flange, and the second lower flange may extend inwardly towards the second lower flange.

In another aspect of the present disclosure, a bracket assembly is disclosed for an electronics module that is configured for insertion into an instrument panel in a vehicle. The bracket assembly includes a first bracket having: a trunk defining a longitudinal axis; an upper flange that extends inwardly from the trunk in transverse relation to the longitudinal axis; a lower flange that extends inwardly from the trunk in transverse relation to the longitudinal axis; and a boss that extends outwardly from the trunk in transverse relation to the longitudinal axis.

In certain embodiments, the upper flange and the lower flange may each define an opening that is configured to receive a fastener.

In certain embodiments, the trunk may include a mounting plate that is located between the upper flange and the lower flange.

In certain embodiments, the mounting plate may define a plurality of openings that are each configured to receive a fastener.

In certain embodiments, the boss may define an arcuate outer surface.

In certain embodiments, the bracket assembly may further include a second bracket with a configuration mirroring that of the first bracket such that the first bracket and the second bracket are non-identical.

In another aspect of the present disclosure an instrument panel is disclosed that is configured to support an electronics module in a vehicle. The instrument panel includes a first mounting surface defining a first track and a second mounting surface opposite to the first mounting surface and defining a second track. The first track and the second track are (generally) identical in configuration and collectively define a non-linear installation and removal path for the electronics module.

In certain embodiments, the first track and the second track may each include a first segment and a second segment that is offset from the first segment along an axis that extends in (generally) orthogonal relation to a direction of insertion of the electronics module.

In certain embodiments, the first segment and the second segment may be connected by a guide surface that extends in non-orthogonal relation to each of the first segment and the second segment.

### BRIEF DESCRIPTION OF THE DRAWINGS

According to common practice, the various features of the drawings may not be to scale, and may be arbitrarily expanded or reduced for clarity.

FIG. 1 is a front, perspective view of an electronics module installed in an instrument panel of a vehicle.

FIG. 2 is a vertical, perspective, cross-sectional view of the electronics module and the instrument panel.

FIG. 3 is an enlargement of the area of detail identified in FIG. 2.

FIG. 4 is a partial, rear, perspective view illustrating assembly of the electronics module.

FIG. 5 is a front, perspective view of the electronics module during installation into the instrument panel.

FIG. 6 is a front, perspective view of the instrument panel with the electronics module removed.

FIG. 7 is a front, plan view of the instrument panel with the electronics module removed.

FIG. 8 is a front, perspective view of a bracket assembly configured for connection to the electronics module to facilitate installation of the electronics module into the instrument panel.

FIG. 9 is a top, perspective view of the instrument panel illustrating connection of the bracket assembly to a steering member bracket in the vehicle.

FIG. 10 is a front, plan view of instrument panel and the electronics module illustrating connection of the bracket assembly to the steering member bracket in the vehicle.

FIG. 11 is a rear, side, perspective view of the electronics module installed in the instrument panel.

FIG. 12 is a rear, perspective view of the electronics module and the bracket assembly.

FIG. 13 is a partial, top, perspective view illustrating connection of the bracket assembly to the steering member bracket.

FIG. 14 is a schematic view illustrating connection of the bracket assembly to the steering member bracket.

### DETAILED DESCRIPTION

The present disclosure describes the installation (and removal) of an electronics module in a vehicle's instrument panel as well as the associated structures and components. To facilitate installation (and removal) of the electronics module, the instrument panel includes a pair of tracks that are configured to receive bosses extending from brackets that are secured to the electronics module. The tracks include (vertically) offset segments and collectively define a non-linear path followed by the electronics unit during installation (and removal). The vertical offset between the segments of the tracks allows for an adjustment in the vertical (elevational) position of the electronics unit during installation (and removal), which facilitates alignment between corresponding features on the electronics module and the instrument panel to properly orient and secure the electronics module.

Each bracket includes: a trunk that defines a longitudinal axis; upper and lower flanges that extends inwardly from the trunk; and the aforementioned boss, which extends outwardly from the trunk (e.g., in a direction that is (generally) opposite to the flanges). The upper and lower flanges each define an opening that is configured to receive a fastener to secure the brackets in relation to the instrument panel via connection to a steering member bracket in the vehicle.

The electronics module also includes a bezel that is secured to a structural frame of the electronics module (e.g., via heat staking). The bezel extends about a periphery of the electronics module so as to conceal (or other otherwise obscure) any spacing, joints, gapping, etc., between the electronics module and the instrument panel that may otherwise be visible, thereby improving the overall aesthetic impression of the instrument panel by creating a (generally) seamless appearance.

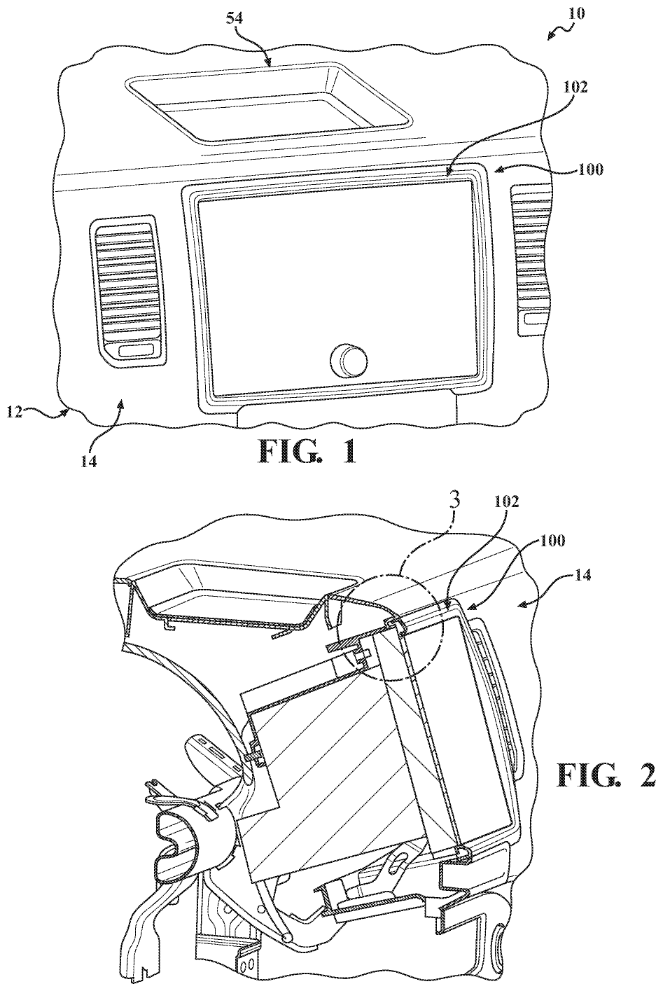

With reference to FIGS. 1-4, a vehicle 10 is disclosed that includes a cockpit module 12 within an instrument panel 14 that is configured to receive and support an electronics module 100. Although generally illustrated and described as an audio unit (e.g., a radio), it should be appreciated that the electronics module 100 may include a variety of other components (e.g., a GPS component, a wireless connectivity component, a video component, etc.) and that the electronics module 100 may be configured to interface with and/or control various systems in the vehicle 10 (e.g., the heating and cooling system, the lighting system, etc.).

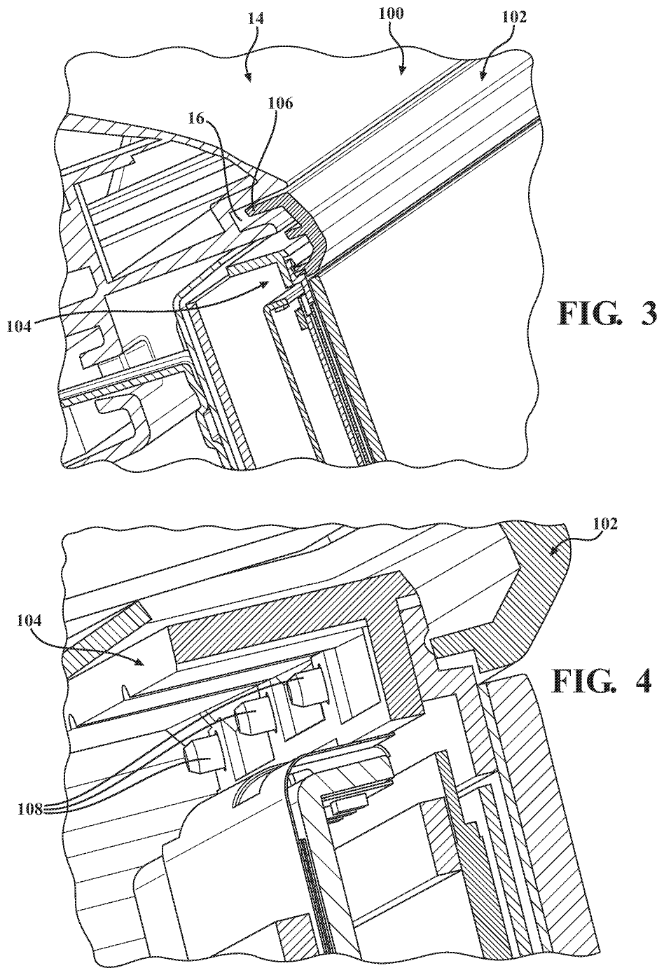

The electronics module 100 includes a bezel 102 that is fixedly connected (secured) to a structural frame 104 thereof and configured to interface with the instrument panel 14. More specifically, the bezel 102 includes a tongue 106 (FIG. 3) that is configured for insertion into a corresponding groove 16 defined by the instrument panel 14. The bezel 102 extends about a periphery of the electronics module 100 so as to conceal (or other otherwise obscure) any spacing, joints, gapping, etc., between the electronics module 100 and the instrument panel 14 and thereby enhance the visual appeal of the cockpit module 12.

The bezel 102 may be connected (secured) to the structural frame 104 of the electronics module 100 in any suitable manner. For example, in the particular embodiment illustrated throughout the figures, the bezel 102 and the structural frame 104 are connected via one or more heat stakes 108 (FIG. 4), which obviates the need for any direct connection between the bezel 102 and the instrument panel 14 (e.g., between the tongue 106 and the groove 16). Other methods of connecting the bezel 102 to the structural frame 104, however, would not be beyond the scope of the present disclosure including, for example, the use of clips or other such mechanical fasteners, which may permit selective separation of the bezel 102 from structural frame 104.

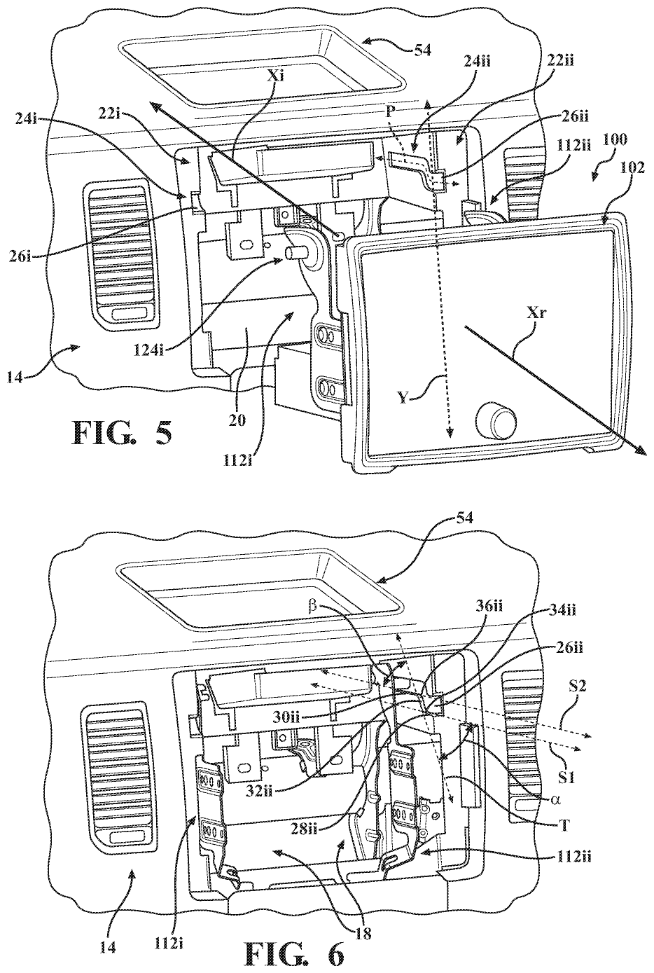

With reference now to FIGS. 5-14 as well, the electronics module 100 is forward (front) mounted in the instrument panel 14 via a guide system 18. More specifically, during installation, the electronics module 100 is inserted into a cavity 20 defined by the instrument panel 14 in a direction of insertion Xi (FIG. 5) that extends towards a forward end of the vehicle 10 (e.g., in (generally) parallel relation to the length of the vehicle 10). The forward installation facilitated by the guide system 18 and the configuration of the instrument panel 14 described herein not only serves to enhance the overall aesthetic appearance of the cockpit module 12, but facilitates serviceability of the electronics module 100 by obviating any need to remove the instrument panel 14, details of which are provided below.

The guide system 18 supports the electronics module 100 during installation (and removal) and facilitates forward loading via the application of an axial (pushing) force along the direction of insertion Xi such that the electronics module 100 slides relative to the instrument panel 14. As elaborated on below, the configuration of the guide system 18 obviates the need for (manual) lateral support of the electronics module 100 by the installer, which facilitates the establishment of any necessary electrical connections between the electronics module 100 and the vehicle 10 during installation.

The guide system 18 includes opposing (first and second) mounting surfaces 22i, 22ii (FIG. 7), which are provided on the instrument panel 14, and a bracket assembly 110 that includes (first and second) brackets 112i, 112ii (FIGS. 6, 8, 12), which are configured for respective engagement with the mounting surfaces 22i, 22ii.

The mounting surface 22i defines a (first) track 24i that is configured for engagement (contact) with the bracket 112i and the mounting surface 22ii defines a (second) track 24ii that is configured for engagement (contact) with the bracket 112ii. The tracks 24i, 24ii are (generally) identical in configuration and respectively include: ingresses/egresses 26i, 26ii; first (rear, lower) segments 28i, 28ii; and second (forward, upper) segments 30i, 30ii. The segments 28, 30 are offset along an axis Y (FIG. 5) that extends in (generally) orthogonal relation to the direction of insertion Xi of the electronics module 100 and are positioned at different vertical heights in the instrument panel 14. Due to the vertical offset between the segments 28, 30, the electronics module 100 follows a non-linear path P during installation into (and removal from) the instrument panel 14. As the electronics module 100 moves along the path P, the vertical (elevational) position of the electronics unit 100 is adjusted, which facilitates proper alignment of the instrument panel 14 during installation, as described in further detail below.

As seen in FIGS. 6 and 7, for example, the track 24i includes a guide surface (transition) 32i that connects (and extends between) the segments 28i, 30i and the track 24ii includes a guide surface (transition) 32ii that connects (and extends between) the segments 28ii, 30ii. The guide surfaces 32 extend in non-orthogonal relation to the segments 28, 30 along an axis T (FIG. 6) that defines corresponding (generally identical) angles α, β with axes S1, S2 respectively defined by the segments 28, 30. In the particular embodiment illustrated throughout the figures, the tracks 24 are configured such that the angles α, β lie substantially within the range of approximately 30° to approximately 60° (e.g., approximately 45°). It should be appreciated, however, that the configuration of the tracks 24 may be altered to vary the angles α, β as necessary or desired. As such, values for the angles α, β outside the aforementioned range are also contemplated herein (e.g., depending on the particular configuration of the instrument panel 14, the particular configuration of the electronics module 100, spatial constraints, etc.) and would not be beyond the scope of the present disclosure.

To further facilitate movement of the electronics module 100 between the segments 28, 30, the track 24i includes a (first, lower) interface 34i (FIG. 7) that is located between the segment 28i and the guide surface 32i and a (second, upper) interface 36i that is located between the segment 30i and the guide surface 32i. Similarly, the track 24ii includes a (first, lower) interface 34ii (FIG. 6) that is located between the segment 28ii and the guide surface 32ii and a (second, upper) interface 36ii that is located between the segment 30ii and the guide surface 32ii. As seen in FIGS. 6 and 7, the interfaces 34, 36 each include a radiused configuration which imparts a (generally) S-shaped configuration to the tracks 24.

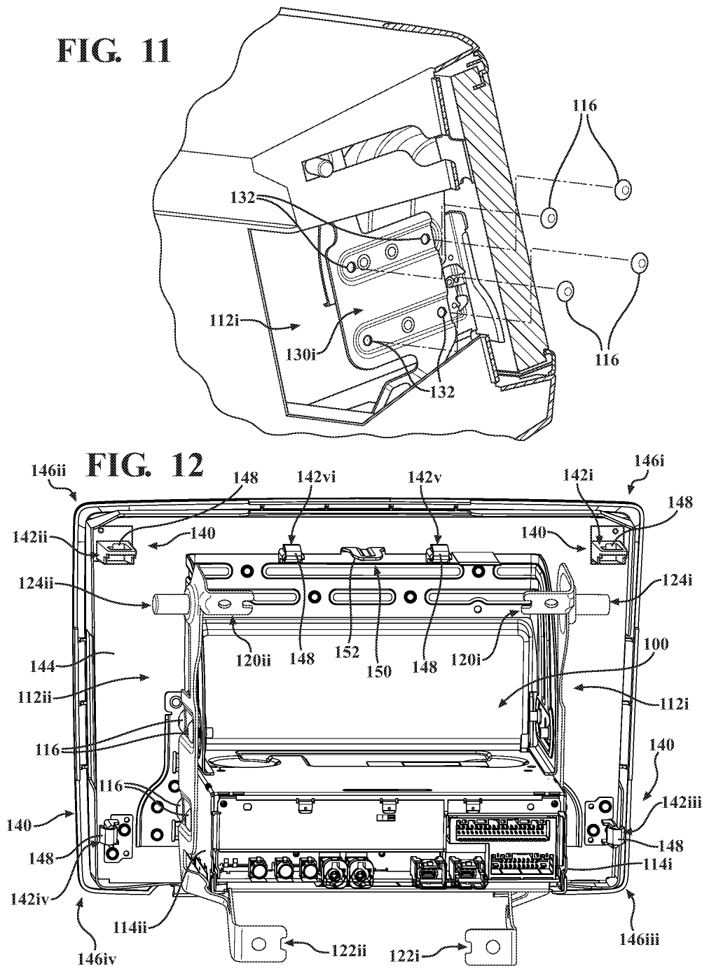

The bracket assembly 110 is configured for connection to the electronics module 100 and provides an interface between the electronics module 100 and the instrument panel 14. More specifically, the brackets 112i, 112ii are (mechanically) secured to opposing lateral ends (sides) 114i, 114ii (FIG. 12) of the electronics module 100 via one or more fasteners 116 (e.g., screws, pins, rivets, clips, etc.).

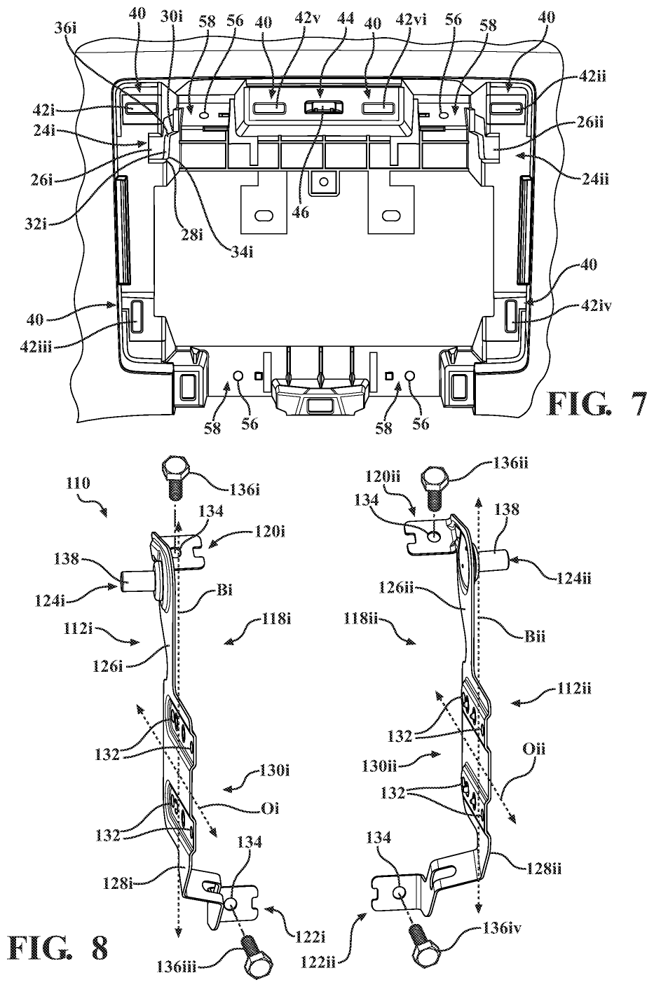

The brackets 112i, 112ii include corresponding, non-identical configurations that are mirror-images of each other, which supports orientation of the brackets 112i, 112ii on the lateral ends 114i, 114ii of the electronics module 100, respectively. More specifically, with reference to FIG. 8, the bracket 112i includes: a trunk 118i; respective upper and lower (first and second) flanges 120i, 122i that extend inwardly from the trunk 118i (e.g., towards the bracket 112ii); and a boss 124i that extends outwardly from the trunk 118i (e.g., away from bracket 112ii). Similarly, the bracket 112ii includes: a trunk 118ii; respective upper and lower (first second) flanges 120ii, 122ii that extend inwardly from the trunk 118ii (e.g., towards the bracket 112i); and a boss 124ii that extends outwardly from the trunk 118ii (e.g., away from bracket 112i).

Each trunk 118 extends along a longitudinal axis B and includes respective upper and lower (first and second) legs 126, 128 and a mounting plate 130 that is located between the legs 126, 128. More specifically, the trunk 118i extends along a longitudinal axis Bi and includes: an upper (first) leg 126i; a lower (second) leg 128i that is offset from the upper leg 126i along an axis Oi that extends in (generally) parallel relation to the direction of insertion Xi; and a mounting plate 130i. Similarly, the trunk 118ii extends along a longitudinal axis Bii and includes: an upper (first) leg 126ii; a lower (second) leg 128ii that is offset from the upper leg 126ii along an axis Oii that extends in (generally) parallel relation to the direction of insertion Xi; and a mounting plate 130ii.

Each mounting plate 130 defines opening(s) 132 that are configured to receive the aforementioned fastener(s) 116 to secure the corresponding bracket 112 to the electronics module 100. While each mounting plate 130 is illustrated as being (generally) square-shaped in configuration, it should be appreciated that the particular geometrical configuration of the mounting plates 130 may be varied in alternate embodiments without departing from the scope of the present disclosure (e.g., depending on the particular configuration of the instrument panel 14, the particular configuration of the electronics module 100, spatial constraints, etc.).

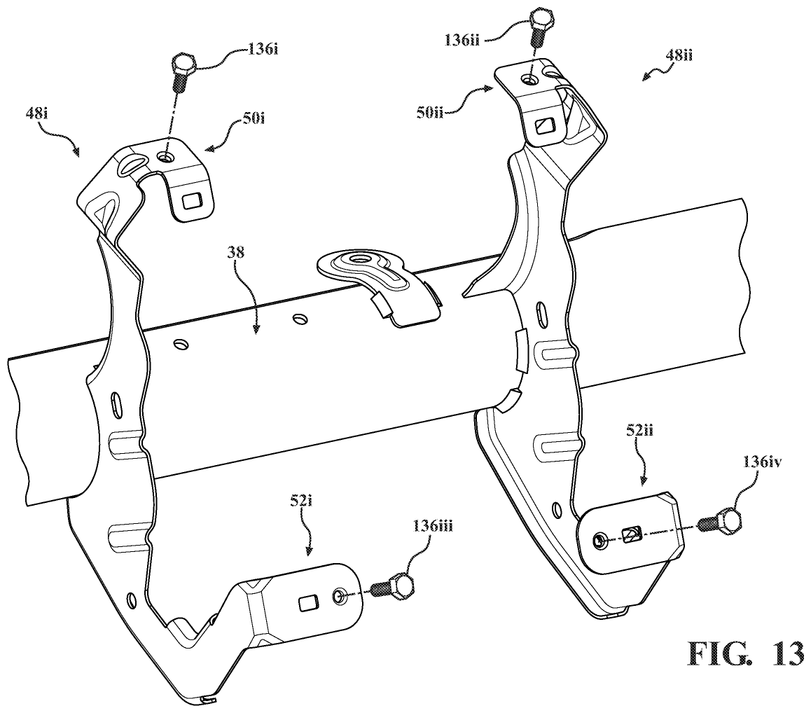

The flanges 120 extends in transverse (e.g., (generally) orthogonal) relation to the longitudinal axis B defined by the trunk 118 of the corresponding bracket 112 (and the direction of insertion Xi of the electronics module 100). Each flange 120 defines an opening 134 that is configured to receive a fastener 136 (FIGS. 8, 13) (e.g., a screw, a pin, a rivet, a clip, etc.) to connect the corresponding brackets 112 to a steering member 38 in the vehicle 10, as described in further detail below. More specifically, the flanges 120i, 120ii extend towards each other and are configured to receive respective (first and second) fasteners 136i, 136ii and the flanges 122i, 122ii extend towards each other and are configured to receive respective (third and fourth) fasteners 136iii, 136iv. As seen in FIG. 12, for example, in the particular embodiment of the disclosure illustrated, whereas the flanges 120i, 120ii are each oriented in non-parallel relation to the vertical axis Y (along which the segments 28, 30 of the tracks 24 are offset), the flanges 122i, 122ii are each oriented in (generally) parallel relation to the vertical axis Y. It should be appreciated, however, that the particular configurations and/or orientations of the flanges 120, 122 may be altered in various embodiments without departing from the scope of the present disclosure (e.g., depending on the particular configuration of the instrument panel 14, the particular configuration of the electronics module 100, spatial constraints, the particular configuration and/or orientation of the steering member 38, etc.).

The bosses 124 extend in transverse (e.g., (generally) orthogonal) relation to the longitudinal axis B defined by the trunk 118 of the corresponding bracket 112 (and the direction of insertion Xi of the electronics module 100) and are configured for insertion into (receipt by) the tracks 24 defined by the mounting surfaces 22 of the instrument panel 14. More specifically, the boss 124i is configured for insertion into (receipt by) the track 24i and the boss 124ii is configured for insertion into (receipt by) the track 24ii. As seen in FIG. 8, for example, the bosses 124 each define an arcuate outer surface 138, which reduces the surface area of the bosses 124 in contact with the tracks 24, thereby reducing friction and facilitating movement of the electronics module 100 with respect to the instrument panel 14 during installation and removal. Although shown as including a (generally) annular (e.g., circular) cross-sectional configuration in the illustrated embodiment, it should be appreciated that the particular geometrical configuration of the bosses 124 may be varied in alternate embodiments without departing from the scope of the present disclosure.

To secure the electronics module 100 to the instrument panel 14, the electronics module 100 and the instrument panel 14 include corresponding engagement features 140, 40 (FIGS. 12, 7), respectively, that are configured for releasable connection (engagement). In the illustrated embodiment, for example, the electronics module 100 includes a plurality of clips 142 that extend from a forward end (surface) 144 thereof and are configured for removable insertion into corresponding slots (or other such openings) 42 on the instrument panel 14. More specifically, the electronics module 100 includes clips 142i-142iv that are (generally) located along a periphery of the electronics module 100 in corner sections 146i-146iv and configured for insertion into slots 42i-42iv. The electronics module also includes clips 142v, 142vi, which are located between the clips 142i, 142ii and configured for insertion into slots 42v, 42vi. To facilitate connection and disconnection (engagement and disengagement) of the clips 142 and the instrument panel 14, each clip 142 includes a deflectable, chamfered ramp 148 that is configured for contact with the corresponding slot 42 such that as the electronics module 100 is advanced forwardly (along the direction of insertion Xi) and rearwardly (along a direction of removal Xr), the clips 142 are deflected inwardly (e.g., towards the brackets 112i, 112ii).

In various embodiments of the disclosure, it is envisioned that the particular number, location, and/or configuration of the engagement features 140, 40 may be altered (e.g., depending on the particular configuration of the instrument panel 14, the particular configuration of the electronics module 100, spatial constraints, etc.). As such, it should be appreciated that the engagement features 140, 40 may include any structure(s) and/or mechanism(s) suitable for the intended purpose of releasably connecting the electronics module 100 to the instrument panel 14.

To further facilitate proper installation of the electronics module 100, in certain embodiments, such as that illustrated throughout the figures, the electronics module 100 and the instrument panel 14 may include corresponding alignment features 150, 44 (FIGS. 12, 7), respectively. In the particular embodiment illustrated, the electronics module 100 includes a flange 152 that is configured for releasable insertion into a corresponding slot (or other such opening) 46 on the instrument panel 14. Although shown as including a single flange 152 and a single slot 46 in the illustrated embodiment, as discussed in connection with the engagement features 140, 40, it should be appreciated that the particular number, location, and/or configuration of the alignment features 150, 44 may be altered (e.g., depending on the particular configuration of the instrument panel 14, the particular configuration of the electronics module 100, spatial constraints, etc.) in various embodiments of the disclosure and that any structure(s) and/or mechanism(s) may be employed to facilitate proper vertical and horizontal alignment of the electronics module 100 and the instrument panel 14 during installation.

With reference now to FIGS. 1-14, a method of installing the electronics module 100 using the guide system 18 will be discussed. Initially, the bracket assembly 110 is connected to the electronics module 100 by inserting the fasteners 116 (FIGS. 11, 12) into the electronics module 100 through the openings 132 in the mounting plates 130i, 130ii. The electronics module 100 is then oriented such that the bosses 124i, 124ii (FIG. 8) are aligned with the ingresses/egresses 26i, 26ii (FIG. 5) defined by the respective tracks 24i, 24ii, and the electronics module 100 is advanced forwardly into the cavity 20 defined by the instrument panel 14 via the application of an axial force along the direction of insertion Xi.

During forward advancement, the electronics module 100 follows the non-linear path P collectively defined by the tracks 24i, 24ii, which guide the electronics module 100 as the bosses 124 traverse the segments 28. Advancement of the electronics module 100 continues until the bosses 124 are located adjacent to the radiused interfaces 34 (FIGS. 6, 7) between the segments 28 and the guide surfaces 32. Contact with the interfaces 34 provides the installer with tactile feedback as to the respective location of the bosses 124 within the tracks 24 as well as a rest point that allows any necessary electrical connections to be made between the electronics module 100 and the vehicle 10 (e.g., wiring, flexible printed circuits, etc.). During electrical connection, the tracks 24 support the electronics module 100 via engagement (contact) with the bosses 124, which allows for release of the electronics module 100 by the installer.

Following any necessary electrical connection(s), the electronics module 100 is advanced further into the cavity 20 such that the bosses 124 traverse the guide surfaces 32, which elevates (raises) the vertical position of the electronics module 100 relative to the instrument panel 14 to align the engagement features 140, 40 (FIGS. 12, 7) and the alignment features 150, 44. Continued advancement of the electronics module 100 causes insertion of the flange 152 into the slot 46, thereby properly locating the electronics module 100 (e.g., horizontally and vertically) relative to instrument panel 14, as well as insertion of the clips 142 into the slots 42, thereby securing the electronics module 100 to the instrument panel 14, and insertion of the tongue 106 (FIG. 3) on the bezel 102 into the groove 16 defined by the instrument panel 14. Upon receipt of the tongue 106 within the groove 16, the bezel 102 conceals the interface between the electronics module 100 and the instrument panel 14 to diminish the appearance of (if not entirely eliminate) any separation between the electronics module 100 and the instrument panel 14 such that the instrument panel 14 includes a (generally) seamless overall aesthetic appearance.

Following engagement (connection) of the clips 142 and the instrument panel 14, the flanges 120, 122 on the brackets 112 are connected to the instrument panel 14 and the steering member 38 via steering member brackets 48 (FIG. 13) to thereby secure the electronics module 100 in relation to the steering member 38. In the particular embodiment illustrated, the vehicle 10 includes (first and second) steering member brackets 48i, 48ii that are secured to the steering member 38 (e.g., via mechanical fasteners, via welding, etc.), which is connected to the steering column in the vehicle 10 and extends laterally across the width of the vehicle 10 to provide structural support to the cockpit module 12. As seen in FIG. 13, the steering member bracket 48i includes respective upper and lower (first and second) flanges 50i, 52i that are configured and positioned in correspondence with the flanges 120i, 122i on the (electronics module) bracket 112i and the steering member bracket 48ii include respective upper and lower (first and second) flanges 50ii, 52ii that are configured and positioned in correspondence with the flanges 120ii, 122ii on the (electronics module) bracket 112ii.

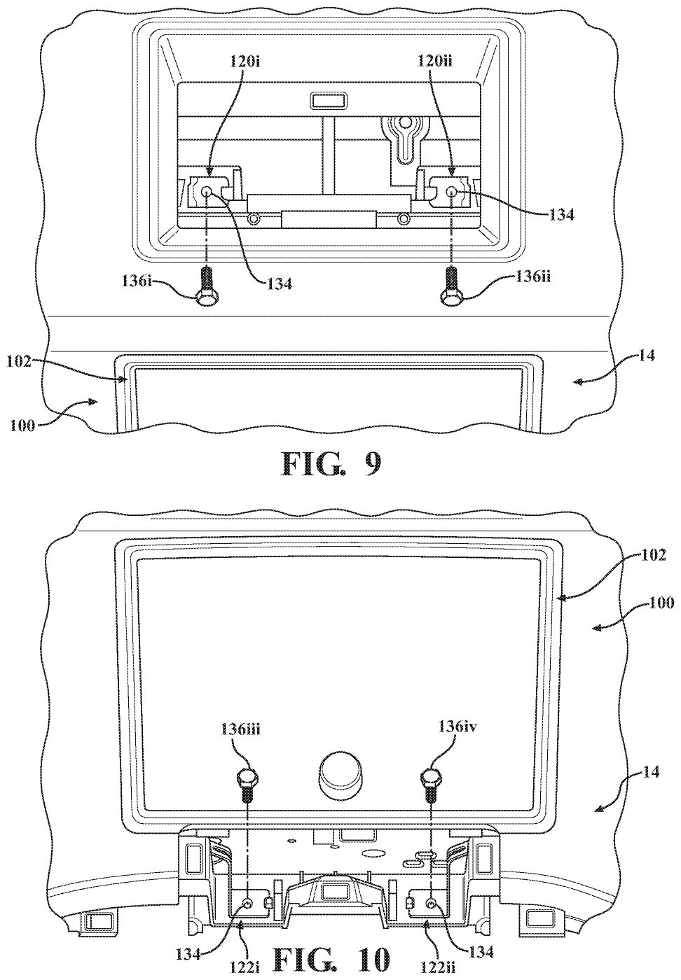

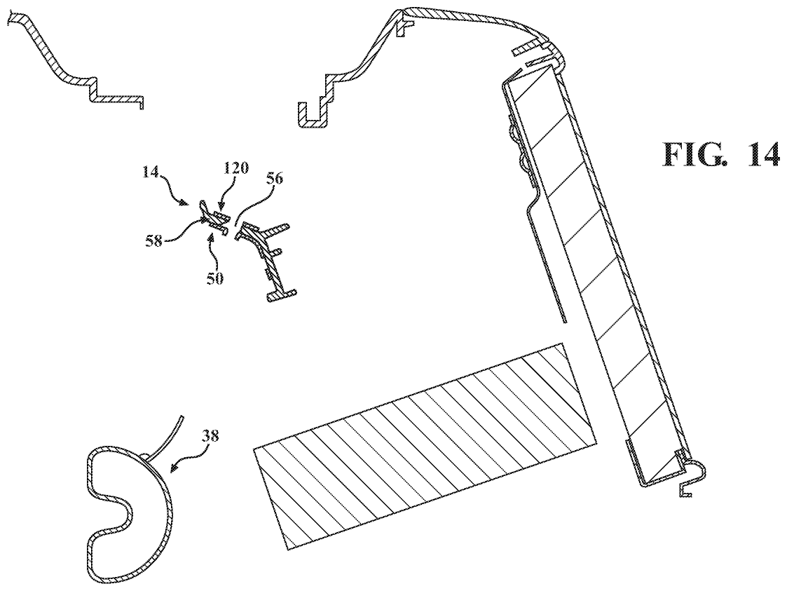

To facilitate connection of the electronics module 100 to the steering member brackets 48i, 48ii, the instrument panel 14 is partially dissembled by removing one or more (e.g., upper and lower) covers 54 (FIG. 1) so as to expose the respective flanges 120i, 122i, 120ii, 122ii of the brackets 112i, 112ii, as seen in FIGS. 9 and 10. The fasteners 136 are then inserted through the openings 134, through openings 56 (FIG. 7) in receiving surfaces 58 on the instrument panel 14, and into the respective flanges 50i, 52i, 50ii, 52ii of the steering member brackets 48i, 48ii such that the receiving surfaces 58 are positioned and secured between the flanges 120, 122 of the (electronics module) brackets 112 and the flanges 50, 52 of the steering member brackets 48, as seen in FIG. 14. The cover(s) 54 are then replaced to conceal the (electronics module) brackets 112.

In the event that service of the electronics module 100 is necessary or desired, the cover(s) 54 (FIG. 1) can be removed to again provide access to the fasteners 136, which can be removed to allow for withdrawal of the electronics module 100 from the instrument panel 14. During withdrawal, an axial (pulling) force is applied to the electronics module 100 in the direction of removal Xr (FIG. 5) such that tongue 106 (FIG. 3) on the bezel 102 is removed from the groove 16 defined by the instrument panel 14 and such that the clips 142 (FIG. 12) are withdrawn from the slots 42 (FIG. 7). As the electronics module 100 is withdrawn, the electronics module 100 follows the non-linear path P (FIG. 5) collectively defined by the tracks 24i, 24ii, during which, the bosses 124 to traverse the segments 30 and the guide surface 32, thereby lowering the vertical position of the electronics module 100 until the bosses 124 come to rest adjacent to the radiused interfaces 34 (FIGS. 6, 7), which allows for electrical disconnection of the electronics module 100 from the vehicle 10. The electronics module 100 can then be withdrawn further from the cavity 20 such that the bosses 124 traverse the segments 28 until they exit the ingresses/egresses 26.

Persons skilled in the art will understand that the various embodiments of the disclosure described herein and shown in the accompanying figures constitute non-limiting examples, and that additional components and features may be added to any of the embodiments discussed herein without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms, such as “comprises,” “includes,” and “having,” should be understood to provide support for narrower terms, such as “consisting of,” “consisting essentially of,” and “comprised substantially of.” Accordingly, the scope of protection is not limited by the description set out above but is defined by the claims that follow and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated. For example, it is intended that the use of terms such as “approximately,” “generally,” and “substantially” should be understood to encompass variations on the order of 25% (e.g., to allow for manufacturing tolerances and/or deviations in design).

Although terms such as “first,” “second,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A vehicle comprising:
an electronics module;
an instrument panel configured to receive the electronics module, the instrument panel including a first track and a second track collectively defining a non-linear installation and removal path for the electronics module;
a first bracket secured to the electronics module and including a first boss configured for insertion into the first track; and
a second bracket secured to the electronics module and including a second boss configured for insertion into the second track.

2. The vehicle of claim 1, wherein the electronics module includes a bezel extending about a periphery thereof and defining a tongue configured for insertion into a groove defined by the instrument panel.

3. The vehicle of claim 2, wherein the bezel is secured to a structural frame of the electronics module.

4. The vehicle of claim 3, wherein the bezel is heat staked to the structural frame of the electronics module.

5. The vehicle of claim 1, wherein the first track and the second track each include a first segment and a second segment offset from the first segment along an axis extending in generally orthogonal relation to a direction of insertion of the electronics module.

6. The vehicle of claim 5, wherein the first track and the second track are generally identical in configuration.

7. The vehicle of claim 1, wherein the first bracket is secured to a first side of the electronics module and the second bracket is secured to a second side of the electronics module opposite to the first side.

8. The vehicle of claim 7, wherein the first bracket and the second bracket are non-identical.

9. The vehicle of claim 8, wherein the second bracket includes a configuration mirroring that of the first bracket.

10. The vehicle of claim 9, wherein the first bracket includes a first upper flange configured to receive a first fastener and a first lower flange configured to receive a second fastener, the second bracket including a second upper flange configured to receive a third fastener and a second lower flange configured to receive a fourth fastener.

11. The vehicle of claim 10, wherein the first upper flange, the second upper flange, the first lower flange, and the second lower flange each extend transversely in relation to a direction of insertion of the electronics module.

12. The vehicle of claim 11, wherein the first upper flange extends inwardly towards the second upper flange, the first lower flange extends inwardly toward the second lower flange, the second upper flange extends inwardly towards the first upper flange, and the second lower flange extends inwardly toward the first lower flange.

13. A bracket assembly for an electronics module configured for insertion into an instrument panel in a vehicle, the bracket assembly comprising:
a first bracket including:
a trunk defining a longitudinal axis;
an upper flange extending inwardly from the trunk in transverse relation to the longitudinal axis;
a lower flange extending inwardly from the trunk in transverse relation to the longitudinal axis; and
a boss extending outwardly from the trunk in transverse relation to the longitudinal axis.

14. The bracket assembly of claim 13, wherein the upper flange and the lower flange each define an opening configured to receive a fastener.

15. The bracket assembly of claim 13, wherein the trunk includes a mounting plate located between the upper flange and the lower flange, the mounting plate defining a plurality of openings each configured to receive a fastener.

16. The bracket assembly of claim 13, wherein the boss defines an arcuate outer surface.

17. The bracket assembly of claim 13, further including a second bracket with a configuration mirroring that of the first bracket such that the first bracket and the second bracket are non-identical.

18. An instrument panel configured to support an electronics module in a vehicle, the instrument panel comprising:
a first mounting surface defining a first track; and
a second mounting surface opposite to the first mounting surface and defining a second track, wherein the first track and the second track are generally identical in configuration and collectively define a non-linear installation and removal path for the electronics module.

19. The instrument panel of claim 18, wherein the first track and the second track each include a first segment and a second segment offset from the first segment along an axis extending in generally orthogonal relation to a direction of insertion of the electronics module.

20. The instrument panel of claim 19, wherein the first segment and the second segment are connected by a guide surface extending in non-orthogonal relation to each of the first segment and the second segment.
